(19) United States
(12) Patent Application Publication
(10) Pub. No.: US 2020/0136708 A1
(43) Pub. Date: Apr. 30, 2020

(54) UPLINK BEAM MANAGEMENT

(71) Applicant: IDAC Holdings, Inc., Wilmington, DE (US)

(72) Inventors: Kyle Jung-Lin Pan, Saint James, NY (US); Fengjun Xi, San Diego, CA (US); Chunxuan Ye, San Diego, CA (US)

(73) Assignee: IDAC Holdings, Inc., Wilmington, DE (US)

(21) Appl. No.: 16/482,307

(22) PCT Filed: Feb. 2, 2018
(86) PCT No.: PCT/US2018/016621

§ 371 Date: Jul. 31, 2019

Related U.S. Application Data
(60) Provisional application No. 62/454,568, filed on Feb. 3, 2017.
(60) Provisional application No. 62/501,021, filed on May 3, 2017.

(51) Int. Cl. H04B 7/06; H04B 7/0408; H04W 74/08; H04W 24/10; H04L 25/02; H04L 5/00

(52) U.S. Cl. CPC H04B 7/0695; H04B 7/0408; H04B 7/0617; H04L 5/0051; H04W 24/10; H04L 25/0226; H04W 74/0833

(57) ABSTRACT

Systems, methods and instrumentalities are disclosed for uplink beam management. A wireless transmit/receive unit (WTRU) may send a beam correspondence indication to a network device. The beam correspondence indication may indicate a beam correspondence associated with one or more receive beams and one or more transmit beams of the WTRU. The WTRU may determine an uplink time synchronization status associated with the WTRU. The uplink time synchronization status may indicate whether the WTRU is uplink time synchronized. The WTRU may receive, from the network device, a reference signal type in accordance with the determined uplink time synchronization status. The WTRU may receive, from the network device, a beam management indication in response to the beam correspondence indication. The WTRU may perform an uplink beam management based on the received beam management indication.

### CROSS REFERENCE TO RELATED APPLICATIONS

This application is the National Stage entry under 35 U.S.C. § 371 of Patent Cooperation Treaty Application PCT/US2018/016621, filed Feb. 2, 2018, which claims priority to U.S. provisional patent application No. 62/454,568, filed Feb. 3, 2017, and U.S. provisional patent application No. 62/501,021, filed May 3, 2017, which are incorporated herein by reference in their entirety.

### BACKGROUND

Mobile communications continue to evolve. A fifth generation may be referred to as 5G. A previous (legacy) generation of mobile communication may be, for example, fourth generation (4G) long term evolution (LTE). Mobile wireless communications implement a variety of radio access technologies (RATs), such as New Radio (NR). Use cases for NR may include, for example, extreme Mobile Broadband (eMBB), Ultra High Reliability and Low Latency Communications (URLLC) and massive Machine Type Communications (mMTC).

### SUMMARY

Systems, methods, and instrumentalities are disclosed for uplink beam management. A wireless transmit/receive unit (WTRU) may send a beam correspondence indication to a network device. The WTRU may include a memory and/or a processor. The network device may be a transmission reception point (TRP). The beam correspondence indication may indicate a beam correspondence associated with one or more receive beams and one or more transmit beams of the WTRU. The beam correspondence indication may indicate a change (e.g., a temporary change) in the beam correspondence. The beam correspondence may include a WTRU side beam correspondence and/or a network device side beam correspondence. The beam correspondence may indicate that the WTRU is capable of determining a transmit beam of the WTRU based on a downlink measurement. The downlink measurement may be measured by the WTRU on one or more receive beams of the WTRU. The beam correspondence may indicate that the WTRU is capable of determining a receive beam of the WTRU based on an uplink measurement. The uplink measurement may be measured by the WTRU on one or more transmit beams of the WTRU.

The WTRU may determine an uplink time synchronization status associated with the WTRU. The uplink time synchronization status may indicate whether the WTRU is uplink time synchronized. The WTRU may receive, from the network device, a reference signal type. The reference signal type may be in accordance with the determined uplink time synchronization status. For example, the reference signal type may be a new radio (NR) sounding reference signal (SRS) when the WTRU is uplink time synchronized. As another example, the reference signal type may be a NR physical random access channel (PRACH) preamble when the WTRU is not uplink time synchronized.

The WTRU may receive, from the network device, a beam management indication, for example, in response to the beam correspondence indication. The beam management indication may include a beam management configuration associated with the beam correspondence. The WTRU may perform an uplink beam management based on the received beam management indication. The uplink beam management may include sending one or more reference signals from a subset of WTRU transmit beams based on the beam correspondence. The one or more reference signals sent in the uplink beam management may have the reference signal type received from the network device. The uplink beam management may include performing a reduced set of measurements when compared to an uplink beam management with no beam correspondence. The uplink beam management may include skipping one or more beam measurements based on the beam correspondence. The WTRU may use one or more downlink measurements for the one or more skipped beam measurements.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 is an example of a Transmission/Reception Point (TRP) and Wireless Transmit/Receive Unit (WTRU) antenna model.

FIG. 3 is an example of a UL beam Management configuration with RS type and signal format selection.

FIG. 4 is an example of an NR-PRACH signal format for UL Beam Management.

FIG. 5 is an example of U2 and U3 with NR-PRACH preamble format A and format B.

FIG. 6 is an example of UL beam management configuration with beam correspondence.

FIG. 7 is an example of a beam correspondence based beam management.

FIG. 8 is an example of a TRP beam correspondence determination and indication.

FIG. 9 is an example distribution of DMRS and sounding reference signal (SRS) over time and frequency domains.

FIG. 10 is an example of UL beam management for a single TRP.

FIG. 11 is an example of UL beam management for multiple TRPs.

### EXAMPLE NETWORKS THAT MAY BE ASSOCIATED WITH IMPLEMENTATION OF THE EMBODIMENTS

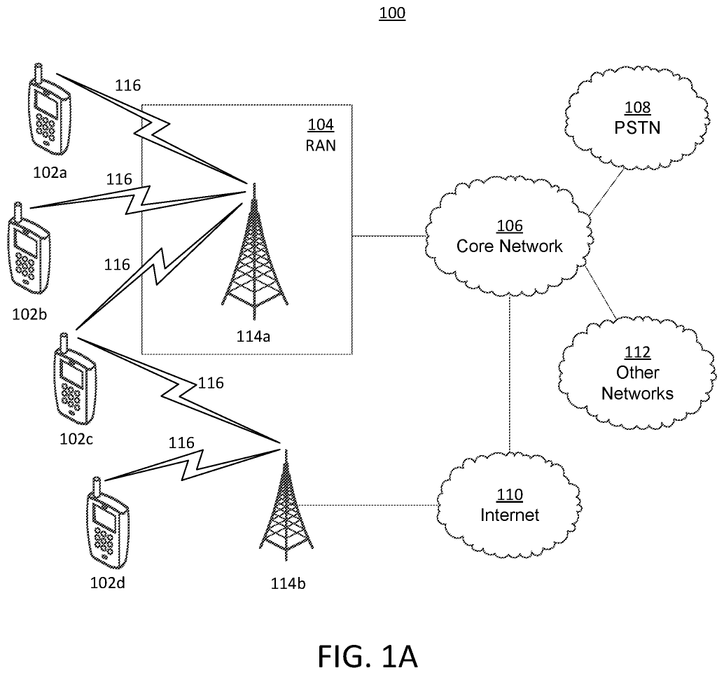

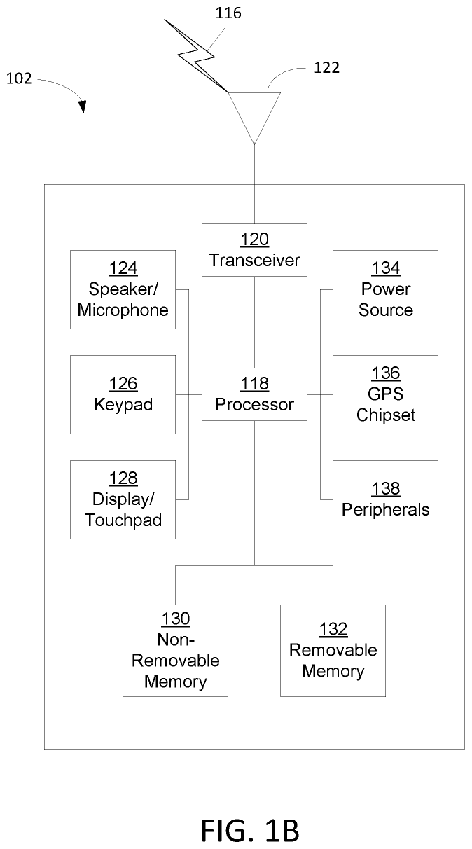

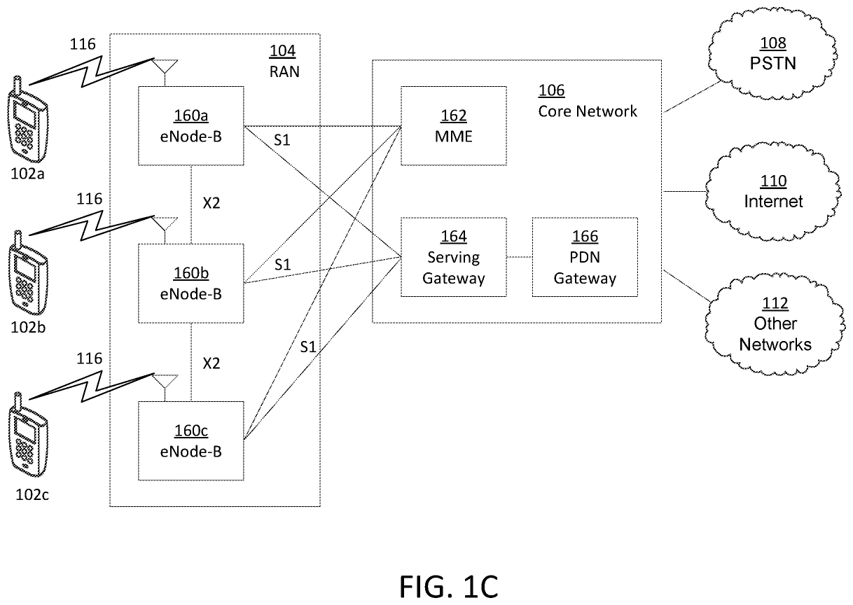

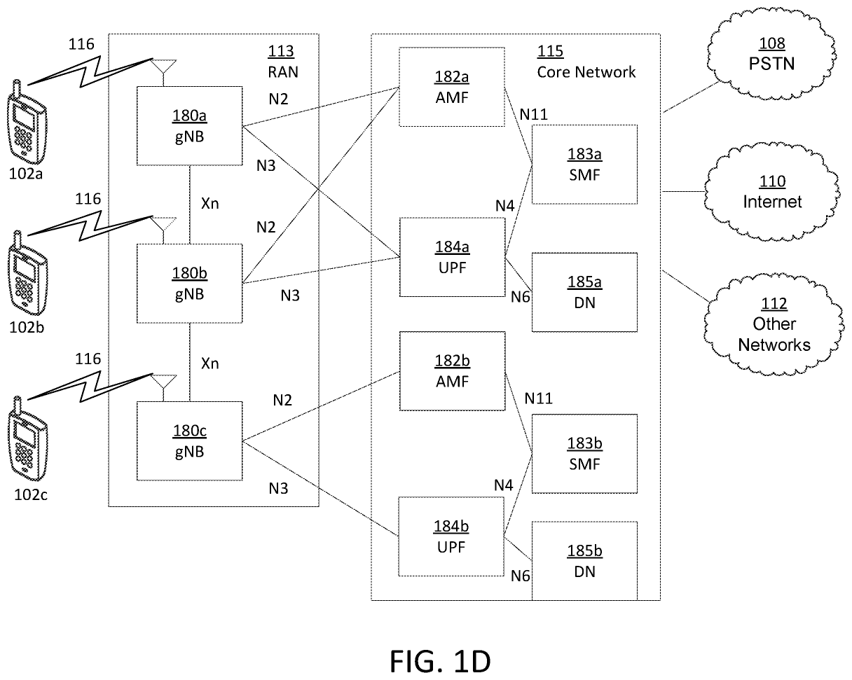

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (loT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a,184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

### DETAILED DESCRIPTION

Next generation mobile communications may support applications such as enhanced mobile broadband (eMBB), massive Machine Type Communications (mMTC) and Ultra-Reliable Low Latency Communications (URLLC) with a wide range of licensed and unlicensed spectrum bands (e.g., ranging from 700 MHz to 80 GHz) for a variety of deployment scenarios.

Multiple antenna transmission and beamforming may be provided. Multiple antenna techniques such as Multiple Input Multiple Output (MIMO) transmission and variations (e.g., Single Input Multiple Output (SIMO) and Multiple Input Single Output (MISO)) may be employed (e.g., for sub-6 GHz transmission). Different MIMO techniques may provide different benefits such as diversity gain, multiplexing gain, beamforming, array gain, etc. User Terminals (UTs) in cellular communication may communicate with a single central node. MU-MIMO may increase system throughput, for example, by facilitating the transmission of multiple data streams to different UTs at the same time on the same and/or overlapping set of resources in time and/or frequency. A central node implementing SU-MIMO may transmit multiple data streams to the same UT, for example, compared to multiple UTs for MU-MIMO.

Multiple antenna transmission at millimeter wave frequencies may differ from sub-6 GHz multiple antenna techniques. This may be due to different propagation characteristics at millimeter wave frequencies and the BTS/WTRU potentially having a limited number of RF chains compared to antenna elements.

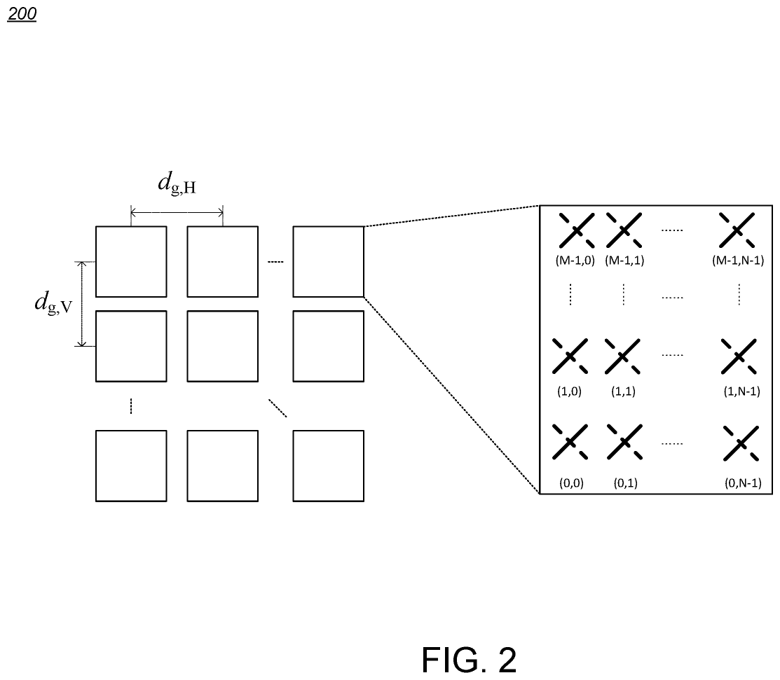

FIG. 2 is an example of a Transmission/Reception Point (TRP) and Wireless Transmit/Receive Unit (WTRU) antenna model 200. The TRP may be a network device (e.g., such as a cell, etc.). An antenna model 200 (e.g., a massive antenna model) may be configured as Mg antenna panels per vertical dimension and Ng antenna panels per horizontal dimension. An (e.g., each) antenna panel may be configured with N columns and M rows of antenna elements with or without polarization (e.g., as shown by an example in FIG. 2). Timing and phase may not be calibrated across panels although multiple panels may be equipped in the same eNB. A baseline massive antenna configuration may vary according to an operating frequency band, for example, as indicated in Table 1. Table 1 provides examples of baseline massive antenna configurations for dense urban and urban macro.

TABLE 1

| At 4 GHz | At 30 GHz | At 70 GHz |
|---|---|---|
| Dense urban and urban macro: | Dense urban and urban macro: | Dense urban: |
| (M, N, P, Mg, Ng) = (8, 8, 2, 1, 1), | (M, N, P, Mg, Ng) = (4, 8, 2, 2, 2), | Baseline: (M, N, P, Mg, Ng) = |
| (dV, dH) = (0.8, 0.5)λ | (d_{V,} d_{H}) = (0.5, 0.5)λ, (d_{g,V}, d_{g,H}) = | (8, 16, 2, 2, 2), (d_{V}, d_{H}) = (0.5, 0.5)λ, |
| | (2.0, 4.0)λ | (d_{g,V}, d_{g,H}) = (4.0, 8.0)λ |
| A single panel | 4 panels | 4 panels |
| 64 elements per Pol. | 32 elements per Pol. | 128 elements per Pol. |
| Total 128 elements | Total 256 elements | Total 1024 elements |

Precoding at millimeter wave frequencies may be digital, analog, or a hybrid of digital and analog. Digital precoding may be precise and may be combined with equalization. Digital precoding may enable single user (SU), multi-user (MU), and multi-cell precoding and may be similar to that used in sub 6 GHz (e.g., in IEEE 802.11n and beyond and in 3GPP LTE and beyond). The presence of a limited number of RF chains compared with antenna elements and the sparse nature of the channel may complicate the use of digital beamforming (e.g., in mmW frequencies). Analog beamforming may overcome the limited number of RF chains, for example, by using analog phase shifters on each antenna element. Analog beamforming may be used in IEEE 802.11ad during Sector Level Sweep (e.g., to identify the best sector), Beam Refinement (e.g., to refine the sector to an antenna beam), and beam tracking (e.g., to adjust sub-beams over time to account for change in the channel) implementations. Hybrid beamforming may divide a precoder between analog and digital domains. Each domain may have precoding and combining matrices with different structural constraints (e.g., constant modulus constraint) for combining matrices in the analog domain. This may result in a compromise between hardware complexity and system performance. Hybrid beamforming may achieve digital precoding performance due to the sparse nature of channels and support for multi-user/multi-stream multiplexing. Hybrid beamforming may be limited by a number of RF chains, which may not be an issue where mmW channels are sparse in the angular domain.

Beam management may be provided, e.g., for NR. Use of higher band frequencies may imply that their propagation characteristics may influence the system design. A channel may experience higher path losses and more abrupt changes as frequencies increase, e.g., due to the fact that transmission through most objects may be reduced, reflections may be amplified, blockage, WTRU rotation and movement may occur.

A large-scale antenna array may be used (e.g., in high frequency bands), for example, to achieve high beamforming gain, e.g., to compensate for high propagation loss. Resulting coupling loss may be kept at a high level, e.g., to support a desired data throughput or coverage. Use of directional beam based communication may involve accurate beam pairing. A correct beam direction may be associated with a real channel, e.g., in terms of an angle of arrival and angle of departure in azimuth and elevation. A correct beam direction may be (e.g., dynamically) adjusted with a channel change.

Beam management implementations may include, for example, downlink (DL) and uplink (UL) beam management implementations. Downlink beam management implementations may have shorthand references such as P-1, P-2, P-3, etc. A downlink beam management implementation may include one or more of P-1, P-2, or P-3. DL beam management may include 3 DL BM procedures denoted as P-1, P-2, and P-3. One or more of P-1, P-2, or P-3 may be implemented for DL BM. Uplink beam management implementations may have shorthand references such as U-1, U-2, U-3, etc. One or more of U-1, U-2, or U-3 may be implemented for UL BM. The DL and UL beam management may include one or more of the following attributes.

In an example, a first downlink beam management implementation (e.g., P-1) may be used to enable WTRU measurement on different TRP Tx beams, e.g., to support selection of TRP Tx beams/WTRU Rx beam(s). P-1 may include an intra/inter-TRP Tx beam sweep from a set of different beams, e.g., for beamforming at a TRP. P-1 may include a WTRU Rx beam sweep from a set of different beams, e.g., for beamforming at a WTRU. A TRP Tx beam and WTRU Rx beam may be determined jointly or sequentially.

In an example, a second downlink beam management implementation (e.g., P-2) may be used to enable WTRU measurement on different TRP Tx beams, for example, to change inter/intra-TRP Tx beam(s), e.g., from a smaller set of beams than P-1 for beam refinement. P-2 may be a special case of P-1.

In an example, a third downlink beam management implementation (e.g., P-3) may be used to enable WTRU measurement on the same TRP Tx beam to change a WTRU Rx beam, for example, when WTRU uses beamforming.

In an example, a first uplink beam management implementation (e.g., U-1) may be used to enable a TRP measurement on different WTRU Tx beams, e.g., to support selection of WTRU Tx beams/TRP Rx beam(s).

In an example, second uplink beam management implementation (e.g., U-2) may be used to enable a TRP measurement on different TRP Rx beams, e.g., to change/select inter/intra-TRP Rx beam(s).

In an example, a third uplink beam management implementation (e.g., U-3) may be used to enable TRP measurement on the same TRP Rx beam, for example, to change a WTRU Tx beam, e.g., when a WTRU uses beamforming.

CSI-RS may support DL Tx beam sweeping and WTRU Rx beam sweeping. CSI-RS may be used, for example, in implementations P-1, P-2, and/or P-3.

NR CSI-RS may support a mapping structure. In an example of a mapping structure, N_{P} CSI-RS port(s) may be mapped per (sub)time unit. One or more CSI-RS antenna ports may be mapped across (sub)time units. A “time unit” may refer to n>=1 OFDM symbols in a configured/reference numerology. OFDM symbols comprising a time unit may or may not be consecutive. A port multiplexing implementation may be, for example, one or more of FDM, TDM, and/or CDM.

A (e.g., each) time unit may be partitioned into sub-time units. A partitioning implementation may be, for example, TDM, interleaved frequency division multiple access (IFDMA), and/or OFDM. An OFDM symbol-level partition may have the same/shorter OFDM symbol length (e.g., larger subcarrier spacing) relative to a reference OFDM symbol length (e.g., subcarrier spacing).

A mapping structure may be used, for example, to support multiple panels/Tx chains.

CSI-RS may be mapped for Tx and Rx beam sweeping. In a (e.g., first) example, Tx beam(s) may be the same across sub-time units within a (e.g., each) time unit. Tx beam(s) may be different across time units. In a (e.g., second) example, Tx beam(s) may be different across sub-time units within a (e.g., each) time unit. Tx beam(s) may be the same across time units. In a (e.g., third) example (e.g., a combination of previous examples), Tx beam(s), e.g., within a time unit, may be the same across sub-time units. Tx beam(s), e.g., within another time unit, may be different across sub-time units. Different time units may be combined, e.g., in terms of number and periodicity. Tx-only or Rx-only sweeping may be implemented.

A mapping structure may be configured with one or more CSI-RS resource configurations.

DL Beam management may use, for example, implementations P-1, P-2, and P-3. Beam correspondence may be fulfilled at a TRP and/or a WTRU. Beam correspondence may be associated with one or more RX and/or TX beams of a TRP and/or a WTRU. For example, beam correspondence may indicate that a WTRU is capable of determining a WTRU TX beam for an uplink transmission based on one or more downlink measurements on one or more WTRU RX beams. As another example, beam correspondence may indicate that a WTRU is capable of determining a WTRU RX beam for a downlink reception (e.g., to use for receipt of a downlink transmission) based on an indication (e.g., from a TRP) associated with an uplink measurement on one or more WTRU TX beams. As another example, beam correspondence may indicate that a TRP is capable of determining a TRP RX beam for an uplink reception (e.g., to use for receipt of an uplink transmission) based on one or more WTRU measurements on one or more TRP TX beams. As another example, beam correspondence may indicate that a TRP is capable of determining a TRP TX beam associated with a downlink transmission based on one or more measurements on one or more TRP RX beams. DL beam management may be used to find suitable TRP TX/RX beams and/or WTRU TX/RX beams. A TRP RX beam and/or WTRU TX beam may not be determined based on DL beam management, for example, when beam correspondence may not be fulfilled at a TRP and/or a WTRU. UL beam management may be used, for example, when beam correspondence may not be fulfilled at a TRP and/or a WTRU.

UL beam management may use, for example, implementations U-1, U-2, and U-3. A TRP may configure UL beam management. A TRP may configure a WTRU beam sweeping. A TRP may select a WTRU Tx beam from the UL beam management and/or UL beam sweeping. A TRP may indicate the selected WTRU Tx beam(s) for UL beam management, UL beam sweeping, and/or UL transmission(s). A reference signal may be used to facilitate efficient UL beam management. For example, the WTRU may send the reference signal to the TRP via one or more Tx beams (e.g., the selected WTRU Tx beam to be swept). UL beam management implementations may be provided, for example, including when UL and DL may be from the same or different TRPs (e.g., from a single TRP or Multi-TRP).

Beam correspondence at TRP and/or WTRU may affect UL beam management implementations. A beam correspondence based implementation for UL beam management may reduce overhead and latency. A WTRU may or may not have a beam correspondence capability, which may be due to a hardware limitation and/or a Tx/Rx antenna configuration. A WTRU may determine a beam correspondence associated with the WTRU. A WTRU may (e.g., temporarily) lose beam correspondence, which may be due to, for example, asymmetric interference between uplink and downlink. The WTRU may detect a loss (e.g., temporary loss) of beam correspondence. WTRU capability related beam correspondence may be reported, e.g., for UL beam management. For example, a WTRU may send a beam correspondence indication to a network device (e.g., such as a TRP or a gNB). The beam correspondence indication may indicate a beam correspondence associated with one or more WTRU Rx beams and one or more WTRU Tx beams. The beam correspondence indication may indicate a temporary change in the beam correspondence.

A TRP may determine and configure an UL beam management implementation (e.g., U-1, U-2, and/or U-3 procedures) that may be used based on, for example, WTRU capability of beam correspondence, beam correspondence status, and/or other criteria.

A TRP may check and determine WTRU status and may configure UL beam management, e.g., based on a determined WTRU status. A TRP may check and determine WTRU status for UL time synchronization. For example, the TRP may check and/or request an UL time synchronization status associated with the WTRU (e.g., of the WTRU). The WTRU may send the uplink time synchronization status to the TRP. A TRP may (e.g., based on a WTRU status) determine a reference signal (RS) type. A TRP may configure a reference signal type for a determined UL beam management implementation. For example, a TRP may (e.g., when a WTRU status is UL time synchronized) determine a sounding reference signal (SRS) to be used. A TRP may configure a reference signal type in accordance with the UL time synchronization associated with a WTRU. A TRP may configure an SRS and resources for the SRS for UL beam management. A TRP may (e.g., otherwise) determine an NR-PRACH preamble to be used. A TRP may configure an NR-PRACH preamble and resources for the NR-PRACH preamble for UL beam management. WTRU status may be UL time synchronized. Use of SRS for UL beam management may reduce a delay between UL beam management and UL data transmission, for example, given that UL channel state information and TRP RX and/or WTRU TX beams may be attained by SRS. An NR-PRACH preamble may be used for UL beam management, for example, when a WTRU status may not be UL time synchronized.

The TRP may send a beam management indication to the WTRU. The beam management indication may be sent in response to a beam correspondence indication received from the WTRU. The WTRU may perform an UL beam management based on the received beam management indication. The UL beam management may include performing a reduced set of measurements (e.g., on a subset of WTRU Tx beams) when the beam correspondence indication indicates a beam correspondence when compared to an UL beam management with no beam correspondence. Beam correspondence may enable a WTRU to perform a reduced set of measurements on Tx and/or Rx beams. For example, the WTRU may skip one or more beam measurements based on the beam correspondence. The WTRU may use one or more DL measurements, in the UL beam management, for the one or more skipped beam measurements (e.g., instead of the one or more skipped beam measurements). The WTRU may determine a WTRU Tx beam based on a DL measurement on one or more WTRU Rx beams, for example, based on a WTRU beam correspondence. The WTRU may determine a WTRU Rx beam based on an UL measurement on one or more WTRU Tx beams, for example, based on a WTRU beam correspondence.

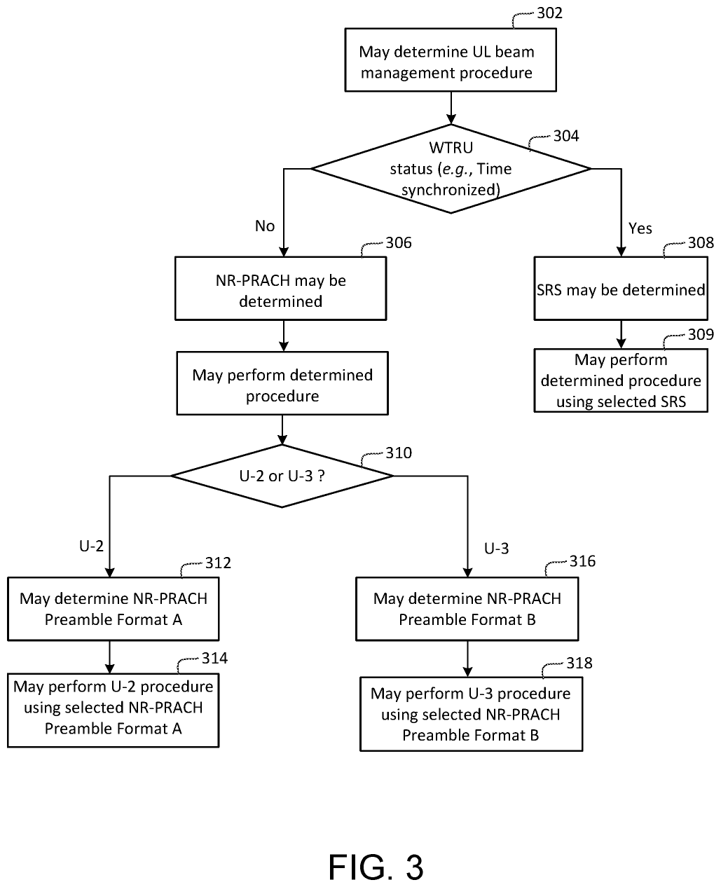

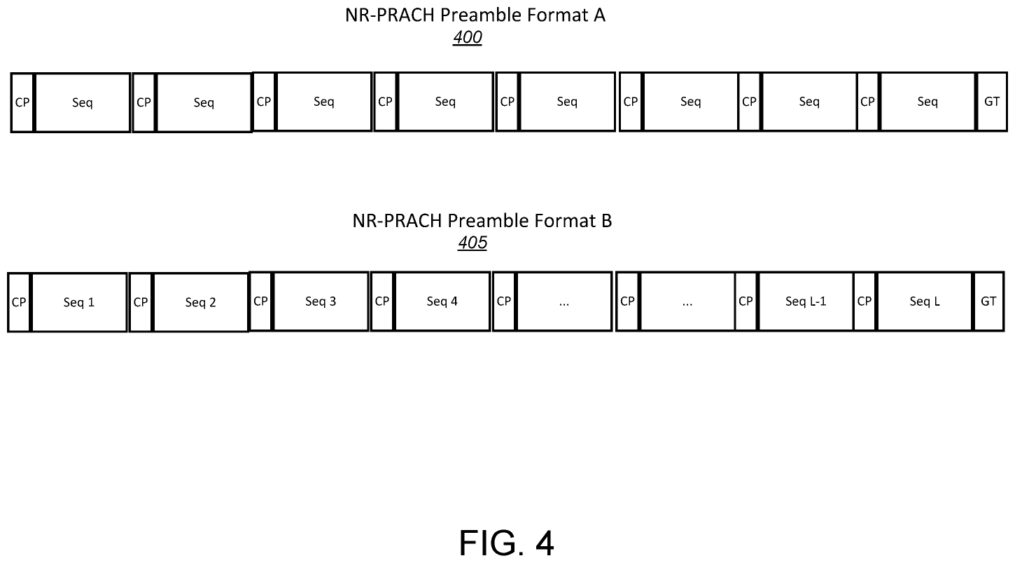

FIG. 3 is an example of a UL beam Management configuration with RS type and signal format selection. An NR-PRACH preamble and resources for the NR-PRACH preamble may be configured for UL beam management. At 302, an UL beam management procedure may be determined. At 304, a WTRU may determine a status associated with the WTRU. The status may include whether the WTRU is UL time synchronized. At 306, the WTRU may determine to use NR-PRACH when the WTRU is not UL time synchronized. At 308, the WTRU may determine to use SRS when the WTRU is UL time synchronized. At 309, the WTRU may determine to perform the determined UL beam management procedure using the SRS. At 310, the WTRU may determine whether to perform U-2 and/or U-3. A signal format may be selected, for example, depending on an implementation used for UL beam management. In an example, at 312, a signal format (e.g., NR-PRACH preamble format A) may be selected, for example, when a U-2 implementation is determined. At, 314, beam management may be performed based on the determined U-2 implementation (e.g., using the determined NR-PRACH preamble and selected NR-PRACH preamble format A). In another example, at 316, a signal format (e.g., NR-PRACH preamble format B) may be selected, for example, when a U-3 implementation is determined. At 318, beam management may be performed based on the determined U-3 implementation (e.g., using the determined NR-PRACH preamble and selected NR-PRACH preamble format B). The TRP may receive and select a WTRU Tx beam (e.g., the best WTRU Tx beam(s)) based on the received NR-PRACH preamble format B. The TRP may send a beam-related indication containing the selected or identified WTRU Tx beam (e.g., the best WTRU Tx beam(s)) to a WTRU by NR-PRACH preamble sequence index used in NR-PRACH preamble format B. A U-1 implementation may be a combination of U-2 and U-3 implementations where multiple UL RS resources and, each UL RS resource consisting of one or multiple OFDM symbols may be configured. NR-PRACH signal formats for UL Beam Management may be depicted in FIG. 4.

FIG. 4 is an example of an NR-PRACH signal format for UL Beam Management. An NR-PRACH signal format for UL Beam Management may include, for example, NR-PRACH preamble format A 400 and NR-PRACH preamble format B 405 (e.g., as shown by example in FIG. 4). A preamble (e.g., NR-PRACH preamble format A 400 and/or NF-PRACH preamble format B 405) may include a number of sequences. The number of sequences may be represented by L. The sequences in a preamble (e.g., NR-PRACH preamble format A 400 and/or NF-PRACH preamble format B 405) may be the same or different. L may be determined based on the number of beams to be swept at a TRP or a WTRU. The TRP may predefine, configure, and/or signal L to the WTRU based on the number of TRP Rx beams to be swept using NR-PRACH preamble format A 400. The TRP may configure and/or signal L to the WTRU by NR-PRACH preamble format B 405, which may be overridden by the WTRU depending on the number of WTRU Tx beams to be swept. For example, if a WTRU transmits preamble in the NR-PRACH signal formats as described herein with a smaller value (e.g., L′) than the signaled L from the network, the WTRU may provide the updated value (e.g., L′) to the TRP to facilitate beam sweeping. L may be the same or different for NR-PRACH signal format A and NR-PRACH signal format B depending on whether TRP and the WTRU may have the same or different beams to be swept.

An NR-PRACH preamble resource(s) may be used to indicate a UL Tx beam(s). The same or different preamble sequences may be sent on the same or different preamble resources. In certain examples, NR-PRACH preamble Format B 405 may use same preamble sequences where the same preamble sequences may be sent on different PRACH preamble resources, e.g., to indicate different UL Tx beams when using NR-PRACH preamble format B 405 for WTRU Tx beam sweeping in a U3 and/or U1 implementations. The TRP may receive and/or select the WTRU Tx beam (e.g., the best WTRU Tx beam(s)) based on the received NR-PRACH preamble format B 405 with the same preamble sequences allocated in different NR-PRACH preamble resources. The TRP may send a beam-related indication containing the selected or identified WTRU Tx beam (e.g., the best WTRU Tx beam(s)) to a WTRU by an NR-PRACH preamble resource indicator.

Multiple NR-PRACH signal formats for UL beam management may be designed to enable efficient UL beam management implementations such as U-1, U-2, and U-3. Such NR-PRACH signal formats may include NR-PRACH preamble format A 400 and NR-PRACH preamble format B 405 as depicted in FIG. 4. In NR-PRACH preamble format A 400 design, a CP may be inserted at the beginning of each of the consecutive multiple and/or repeated RACH OFDM symbols, e.g., L consecutive multiple and/or repeated RACH OFDM symbols. CP between RACH symbols may be inserted, e.g., to handle channel delay spread. A guard time (GT) between RACH symbols may not be inserted. A GT may be used at the end of the consecutive multiple and/or repeated RACH symbol, e.g., to handle propagation delay. In NR-PRACH preamble format B 405 design, multiple and/or repeated RACH sequence or preamble transmissions, which may be similar to NR-PRACH preamble format A 400 design, may be used. In NR-PRACH preamble format B 405 design, different sequences and/or preambles may be used as shown in FIG. 4. In case U-2 implementation is performed, TRP Rx beams may be swept for a fixed WTRU Tx beam. WTRU may transmit the same sequence or preamble repeatedly in RACH OFDM symbols using NR-PRACH preamble format A design. In case U-3 implementation is performed, TRP Rx beam may be fixed while different WTRU Tx beams may be swept. WTRU may transmit different sequences and/or preambles representing different Tx beams in different RACH OFDM symbols using NR-PRACH preamble format B 405 design, e.g., as shown in FIG. 4. A CP may be inserted between the different sequences of NR-PRACH Preamble Format B 405 and/or NR-PRACH Preamble Format A 400. A GT may be used at the end of the different sequences and/or preambles of NR-PRACH Preamble Format B 405 and/or NR-PRACH Preamble Format A 400. Sequence or preamble index may provide Tx beam information or beam identity for WTRU Tx beam in case of U-1 and U3 implementations. This may be used for identifying WTRU Tx beam at TRP. TRP may send a beam-related indication that includes an identified WTRU Tx beam to WTRU.

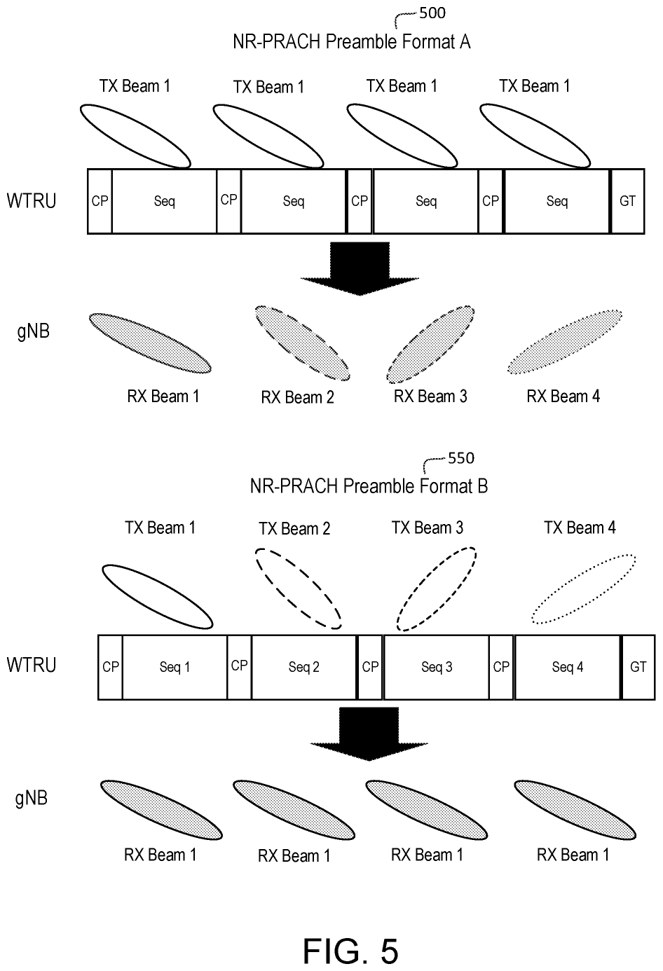

FIG. 5 is an example of U2 and U3 with NR-PRACH preamble format A 500 and NR-PRACH preamble format B 550. FIG. 5 shows an exemplary illustration of TRP 4 Rx beam sweeping using a U2 implementation with an NR-PRACH preamble format A 500 described herein and WTRU 4 Tx beam sweeping using U3 implementation with an NR-PRACH preamble format B 550 described herein. The TRP may select and/or indicate to a WTRU a WTRU Tx beam (e.g., the best WTRU Tx Beam). In the example shown in FIG. 5, based on U3 beam sweeping results, a preamble sequence index (e.g., one of 4 NR-PRACH preamble sequence index) from NR-PRACH preamble format B 550 may be selected and/or sent to a WTRU to indicate a WTRU Tx beam (e.g., the best WTRU Tx beam) by a TRP.

When SRS is determined and used, an UL SRS resource and OFDM symbol may be configured for UL beam management implementation. For example, when U-2 implementation is determined and used, an UL SRS resource consisting of multiple OFDM symbols may be configured. When U-3 implementation is determined and used, multiple UL SRS resources and a (e.g., each) UL SRS resource including one OFDM symbol may be configured. SRS resource indicator may be used to signal a UL Tx beam (e.g., the best UL Tx beam).

Sub-time unit (sub-TU) reference signal such as NR-PRACH preamble, NR-SRS, and/or NR-DMRS may be used for U1/U2/U3 implementations by one or more of large sub-carrier spacing, IFDMA, or discrete Fourier transform (DFT)-based instrumentalities, for example, to save overhead. For example, sub-TU NR-PRACH preamble and/or NR-SRS may be used to create one or more (e.g., to increase) NR-PRACH preamble repetitions within an (e.g., one) OFDM symbol. One repetition group with the same preamble sequence may be used for TRP Rx beam sweeping for a (e.g., one) WTRU Tx beam indicated by a preamble sequence (e.g., the same preamble sequence). The number of repeated preamble sequences with one repetition group may be based on (e.g., equal to) the number of TRP Rx beams to be swept, which may be configured by network or TRP or gNB. The WTRU may perform the Tx beam sweeping from multiple repetition groups.

A TRP may configure a WTRU beam sweep. An implementation (e.g., a U-1 Implementation) may be performed, for example, to identify a coarse beam at a TRP and/or a WTRU. An implementation (e.g., a U-2 Implementation) may be performed, for example, to refine a coarse beam at a TRP. An implementation (e.g., a U-3 Implementation) may be performed, for example, to refine a coarse beam at a WTRU. A beam refinement may include, for example, one or more of the following scenarios: (i) a more precise beam may need to be identified (e.g., when a coarse beam may not be precise); (ii) a narrower beam may need to be identified (e.g., when a coarse beam may be too wide in beamwidth); (iii) a beam with a high(er) resolution may need to be identified (e.g., when a coarse beam may be at a low resolution and/or (iv) a directional beam may need to be identified (e.g., when a coarse beam may be Omni).

A new beam may be identified as a WTRU Tx beam, for example, when implementation U-3 may be performed. A refined beam at WTRU may be, for example, a precise beam, a narrower beam, or a higher resolution beam. A beam-related indication may be sent to a WTRU, e.g., to identify a new beam. A beam-related indication may be carried, for example, in DCI, e.g., via NR-PDCCH or NR-ePDCCH.

A new beam may be identified (e.g., as a TRP RX beam), for example, when implementation U-2 may be performed. There may be a TRP-specific Rx beam for a (e.g., each) WTRU in a different location. A TRP may consider how to handle a multi-user case, for example, when a TRP schedule WTRUs. A TRP may activate multiple TRP Rx beams, for example, when WTRUs are scheduled in the same timeslot or TTI. WTRUs may be scheduled in different PRBs in the frequency domain while being in the same timeslot or TTI. A TRP may activate multiple Rx beams based on the scheduled WTRUs in the timeslot or TTI. A different power control step size may be needed, for example, when different types of TRP Rx beams may be used to serve different WTRUs. For example, a larger power control step size may be used for a wide beam while a small(er) power control step size may be used for a narrow beam.

A TRP may include a beam management type, beam type, reference signal type, and/or resource allocation in the beam management command. A beam management command may, for example, contain one or more of the following: (i) beam management type (e.g., uplink beam management implementation such as U-1, U-2, U-3); (ii) beam type (e.g., different beamwidths and/or resolutions); (iii) reference signal (RS) type (e.g., SRS, PRACH preamble, UL DMRS and/or SR) and/or (iv) transmit power level.

A TRP may request that a WTRU perform a beam sweep using, for example, a specific Tx beam type and/or a specific Tx power level. A different beam type and/or power level may be used or associated with a different UL implementation (e.g., for implementations U-1, U-2, and U-3).

A TRP may configure a resource for a beam sweep. A frequency resource, a time resource, and/or a code resource (e.g., a set or group) may be configured for a UL beam management implementation.

A TRP may (e.g., further) configure one or more of the following (e.g., to WTRU): (i) a signal type association for a (e.g., each) UL implementation (e.g., SRS, PRACH preamble, and/or UL DMRS); (ii) a timeslot or subframe for UL beam management; (iii) UL Status (e.g., a signal type to use may be triggered by Time Advance Valid or Time Advance Invalid, where, for example, Time Advanced Valid (or In-Sync) may trigger use of SRS and/or UL DMRS and Time Advanced Invalid (or Out-of-Sync) may trigger use of PRACH preamble); (iv) time unit or sub-time unit based beam sweep (e.g., IFDMA, large subcarrier spacing based, or DFT-based); (v) local or global beam sweep for U-2 and U-3; (vi) number of repetitions needed for U-3; (vii) WTRU Tx beam-related indication; (viii) TRP beam correspondence capability (e.g., in a static manner) and/or (ix) TRP beam correspondence status (e.g., in a dynamic or semi-static manner)

A TRP may measure a reference signal transmitted from a WTRU using, for example, a requested beam type and power level. A TRP may decide and may indicate a selected beam for a WTRU UL transmission.

A TRP may select one or more WTRU Tx beams, e.g., after U-1 or U-3 implementation. A TRP may send a beam-related indication to a WTRU. Beam related information may include, for example, one or more of the following: (i) one or more selected WTRU Tx beam indexes; (ii) a corresponding RSRP, SINR, CSI, or CQI for one or more selected WTRU Tx beams; (iii) one or more (e.g., best) UL beam pairs (e.g., WTRU's TX beam and/or TRP's RX beam); and/or (iv) one or more backup UL beam pairs, etc.

A TRP may schedule a WTRU to use an identified Tx beam for a specific beam type and power level. A TRP may (e.g., also) schedule a WTRU to use an identified Tx beam for other beam types and power levels. A WTRU may convert an identified Tx beam to another new Tx beam for another beam type and may use different power level. This may be useful, for example, for beam adaptation and joint beam/link adaptation. In an example, a TRP may schedule a WTRU to transmit using a wider beam at higher power due to, for example, mobility, coverage, and/or for an uplink control channel.

A TRP may schedule a WTRU to transmit using a narrower beam at lower power level due to, for example, a higher data rate, a higher link quality, for a data channel, and/or for reduced interference to other TRPs.

A TRP may have flexible scheduling for beams. For example, a TRP may override original beam sweep settings for RS and request that a WTRU convert original beam sweep settings to new or different settings for data and/or control transmission. An offset of beamwidth and power level may be introduced, for example, when beam type and Tx power may be converted from one setting to another setting. A base beam type and power level may be predetermined. Other beam types and power levels may be applied as or applied to an offset to a base setting. Offsets and their values may be predetermined.

A TRP may include a beam type in a beam-related indication (e.g., in DCI), which may include, for example, one or more of the following: i) a beam type, (ii) WTRU Tx Beam information for an original beam type (e.g., used in beam management such as uplink implementations U-1, U-2, U-3) and/or (iii) offset values for beamwidth and/or a Tx power level.

A WTRU may convert an original beam type, beam information and/or beam ID to an indicated beam type, beam information, and/or beam ID for an indicated beam type. An indicated beam type may be another beam type (e.g., not used in U-1, U-2, U-3) that may be used for data or control transmission. One or more associations between beam types and their beam information or IDs may be used. A WTRU may apply offset values in beamwidth and power level, for example, based on an indicated beam type.

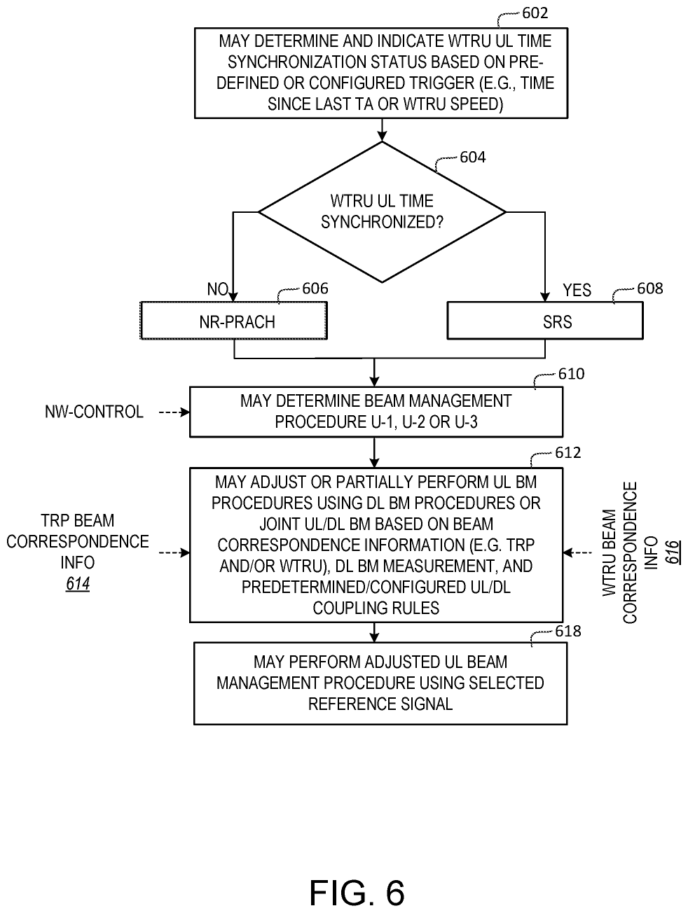

FIG. 6 is an example of UL beam management configuration with beam correspondence. UL beam Management may be configured, for example, with beam correspondence. At 602, a TRP may determine and/or indicate a WTRU situation or status (e.g., such as an UL time synchronization status). For example, a WTRU UL time synchronization status may be determined based on a pre-defined or configured rule or trigger (e.g., a time, or timer, since last time advance (TA) command and/or a WTRU speed) by WTRU or TRP. At 602, the TRP may determine a time value associated with the WTRU status (e.g., time since last TA, time in state, etc.). The TRP may determine whether the WTRU status has changed or is unchanged. For example, if a timer (e.g., a time since a last TA) has exceeded a threshold, the WTRU may not be synchronized. At 604, the TRP may determine whether the WTRU is time synchronized. The TRP may (e.g., based on the WTRU situation or status) determine and configure a signal type and signal format, e.g., RS type and format. At 606, the TRP may configure NR-PRACH if the WTRU is UL time synchronized. At 608, the TRP may configure SRS if the WTRU is not UL time synchronized. At 610, a TRP may determine a beam management implementation to be used, e.g., U-1, U-2, or U-3. At 612, a beam management implementation may be adjusted based on, for example, beam correspondence information. For example, an UL beam management procedure may be adjusted or partially performed using DL beam management procedures.

An adjusted beam management implementation may be a joint UL and DL beam management implementation. An UL implementation (e.g., U-1, U-2, or U-3) and a DL implementation (e.g., P-1, P-2, or P-3) may be mixed and/or may be jointly used in an adjusted beam management implementation. A joint UL/DL beam management may be adjusted or partially performed based on beam correspondence information, one or more DL beam management measurements, and/or a predetermined or configured UL/DL coupling rule. Beam correspondence information may include TRP beam correspondence information 614 and/or WTRU beam correspondence information 616. A beam management implementation may be performed, for example, using a determined and configured UL implementation (e.g., U-1, U-2, or U-3), a determined or configured signal type, and a signal format. At 618, a beam management implementation may be performed, for example, using a determined, configured and adjusted joint/mixed UL/DL implementation (e.g., U-1, U-2, or U-3 and P-1, P-2, or P-3) using a determined or configured signal type and signal format. A joint UL/DL beam management procedure may be achieved within one subframe, one TTI, or one slot: some RS association between DL reference signal (e.g., CSI-RS or SS-block) and UL reference signal (e.g., SRS or PRACH preamble) may be used or configured for the joint UL/DL beam management. Joint triggering of sequential UL and DL procedures may be used for beam training, for example, to reduce the latency and help UL data transmission. For example, U-2 and P-3 procedures may be jointly configured for beam training, for example, to provide a fast UL data transmission.

UL beam management may be used to determine one or more (e.g., all) TRP TX/RX beams and/or WTRU TX/RX beams, for example, when beam correspondence may be fulfilled at a TRP and/or a WTRU. UL beam management may be used (e.g., alternatively to DL beam management) to determine one or more (e.g., all) TRP TX/RX beams and/or WTRU TX/RX beams. DL or UL beam management may be used, for example, depending on the use case and requirements.

UL beam management may be based on beam correspondence.

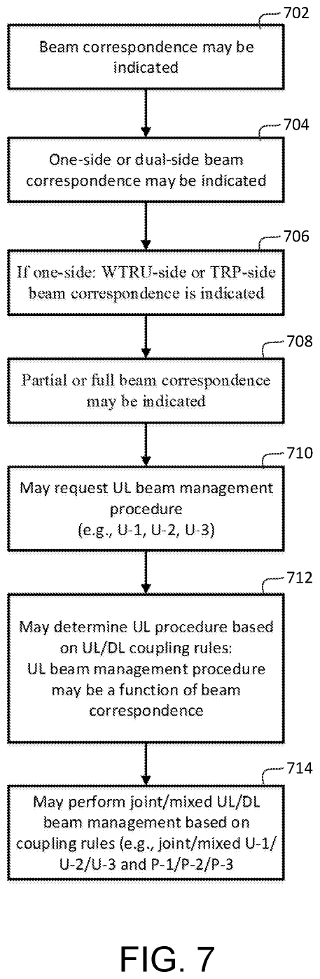

FIG. 7 is an example of a beam correspondence based beam management.

An implementation (e.g., a U-1 implementation) may be used to enable a gNB or TRP measurement on different WTRU Tx beams, for example, to support selection of WTRU Tx beams and/or gNB or TRP Rx beams. An implementation (e.g., a U-2 implementation) may be used to enable gNB or TRP measurement on different gNB or TRP Rx beams, for example, to switch, change, select, or reselect inter or intra-TRP Rx beams. An implementation (e.g., a U-3 implementation) may be used to enable a TRP measurement on the same TRP Rx beam, for example, to switch or change a WTRU Tx beam, e.g., when a WTRU uses beamforming. An implementation (e.g., a U-1 implementation) may (e.g., when beam correspondence or reciprocity may not be available), for example, require a full beam sweep for Tx and Rx beams at gNB or TRP Rx beams and WTRU Tx beams. An implementation (e.g., a U-2 implementation) may, for example, require a full beam sweep for Rx beams at gNB or TRP. An implementation (e.g., a U-3 implementation) may, for example, require a full beam sweep for Tx beams at a WTRU. A full beam sweep may be scaled down to a limited full beam sweep or localized beam sweeping, for example, when there may be (e.g., prior) knowledge about an event that triggered one or more implementations (e.g., U-2 and U-3 implementations). A gNB or TRP may indicate to a WTRU, for example, one or more of the following: (i) a type of beam sweep (e.g., full beam sweep, limited beam sweep, localized beam sweep, or hierarchical beam sweep); (ii) a timeslot or subframe for a beam sweep; (iii) when to start a beam sweep; (iii) a duration of a beam sweep; and/or (iv) a speed of a beam sweep (e.g., using regular time unit or sub-time unit based beam sweeping).

Uplink implementations (e.g., U-1, U-2, and U-3) may be simplified, for example, when beam correspondence or reciprocity is available. Simplified UL beam management may depend on, for example, a type of beam correspondence or reciprocity (e.g., partial or full correspondence or reciprocity). Simplified UL beam management may (e.g., also) depend on a type of beam correspondence or reciprocity (e.g., one-side or dual-side beam correspondence or reciprocity). One-side beam correspondence or reciprocity may be, for example, at a WTRU-side or a TRP-side. Dual-side beam correspondence or reciprocity may be, for example, when both TRP and WTRU have beam correspondence or reciprocity.

FIG. 7 is an example of a beam correspondence based beam management. At 702, a beam correspondence may be indicated by a WTRU and/or a TRP. At 704, the beam correspondence may be one sided or dual-sided. At 706, WTRU-side or TRP-side beam correspondence may be indicated if the beam correspondence is one sided. At 708, a partial or full beam correspondence may be indicated. At 710 an UL beam management procedure (e.g., U-1, U-2, or U-3) may be requested. At 712, an UL procedure may be determined based on one or more UL/DL coupling rules. For example, an UL beam management procedure may be a function of beam correspondence. At 714, a joint/mixed UL/DL beam management may be performed (e.g., by the WTRU or the TRP) based on the one or more coupling rules. For example, the UL/DL beam management may include joint/mixed U-1/U-2/U-3 and/or P-1/P-2/P-3. A joint UL/DL beam management procedure may be achieved within one subframe, one TTI, or one slot: some RS association between a DL reference signal (e.g., CSI-RS or SS-block) and an UL reference signal (e.g., SRS or PRACH preamble) may be used and/or configured for the joint UL/DL beam management procedure.

There may be WTRU-side beam correspondence.

Uplink implementations (e.g., U-1, U-2, and U-3) may (e.g., when WTRU-side beam correspondence is indicated) be coupled with downlink implementations (e.g., P-1, P-2, and P-3), for example, to simplify UL beam management. Beam management may be simplified, for example, using one or more of the following rules: (i) an uplink implementation (e.g., U-1) may be reduced based on a downlink implementation (e.g., P-1) and/or (ii) an uplink implementation (e.g., U-3) may be skipped based on a downlink implementation (e.g., P-3).

An uplink implementation (e.g., U-1) may be coupled with a downlink implementation (e.g., P-1), for example, to simplify the uplink implementation. In an example, a P-1 implementation may be performed. A best coarse TRP Tx beam and WTRU Rx beam may be identified. A best coarse WTRU Tx beam (e.g., based on an identified WTRU Rx beam) may be derived or known. A U-1 implementation may be simplified, for example, to perform a half cycle U-1 implementation.

For example, an implementation may be reduced according to one or more of the following examples.

An uplink implementation (e.g., U-1) may perform a full beam sweep for Rx beams at gNB or TRP Rx beams for WTRU Tx beams identified by a downlink implementation (e.g., P-1).

An uplink implementation (e.g., U-2) may be performed (e.g., as usual). For example, a U-2 implementation may use a full or local beam sweep for Rx beams at gNB or TRP for beam refinement.

An uplink implementation (e.g., U-3) may be skipped following a downlink implementation (e.g., P-3). For example, a U-3 implementation may not be needed or may be needed (e.g., only) for beam refinement for within or around identified Tx beams at a WTRU that may be derived from a P-1 implementation.

There may be TRP-side correspondence.

Uplink implementations (e.g., U-1, U-2, and U-3) may (e.g., when TRP-side beam correspondence is indicated) be coupled with downlink implementations (e.g., P-1, P-2, and P-3), for example, to simplify UL beam management. Beam management may be simplified, for example, using one or more of the following rules: (i) an uplink implementation (e.g., U-1) may be reduced based on a downlink implementation (e.g., P-1) and/or (ii) an uplink implementation (e.g., U-2) may be skipped based on a downlink implementation (e.g., P-2).

An uplink implementation (e.g., U-1) may (e.g., for TRP-side beam correspondence) be coupled with a downlink implementation (e.g., P-1), e.g., to simplify the uplink implementation. A downlink implementation (e.g., P-1) may be performed. A best coarse TRP Tx beam and WTRU Rx beam may be identified. The best coarse TRP Rx beam may be derived or known, for example, based on the identified TRP Tx beam. An uplink implementation (e.g., U-1) may be simplified or reduced to perform (e.g., only) a half cycle implementation. In an example, an uplink implementation may be reduced, skipped, or normally executed according to one or more of the following examples: (i) a reduced U-1 implementation may perform a full beam sweep for Tx beams at a WTRU for TRP Rx beams identified by a P-1 implementation; (ii) a U-2 implementation may be skipped following a P-2 implementation. (e.g., a U-2 implementation may be performed following a P-1 or U-1 implementation) and/or (iii) a U-3 implementation may be performed as usual.

One or more uplink implementations (e.g., U-1, U-2, and U-3) may (e.g., when TRP-side beam correspondence is indicated) be coupled with one or more downlink implementations (e.g., P-1, P-2, and P-3) to simplify UL beam management. Beam management may be simplified, for example, by skipping one or more uplink implementations (e.g., U-1, U-2, and U-3) based on one or more downlink implementations (e.g., P-1, P-2, and P-3).

There may be WTRU and TRP beam correspondence.

Uplink implementations (e.g., U-1, U-2, and U-3) may (e.g., when TRP-side and WTRU-side beam correspondence are indicated) be coupled with downlink implementations (e.g., P-1, P-2, and P-3), for example, to simplify UL beam management. Beam management may be simplified, for example, using one or more of the following rules: (i) a U-1 implementation may be skipped when a P-1 implementation has already been performed; (ii) a U-2 implementation may be skipped when a P-2 implementation has already been performed and/or (iii) a U-3 implementation may be skipped when a P-3 implementation has already been performed.

Beam management may be based on beam management RS timeslot availability. DL beam management implementation may be used to assist an UL beam management implementation and vice versa, for example, based on beam correspondence and/or UL/DL coupling rules. A UL implementation may be replaced with a DL implementation and/or vice versa, for example, depending on conditions, such as a timeslot configuration, RS availability, resource constraints, UL/DL traffic, interference, network load, etc. A replacement may be indicated, for example, semi-statically or dynamically. For example, U-1→U-2→U-3 may be triggered and performed. A network may (e.g., based on WTRU beam correspondence) request U-1→U-2→P-3 (instead of U-1→U-2→U-3), for example, when a DL resource and measurement are more available and efficient than UL. A network may (e.g., also or alternatively) request, for example, U-1→P-2→U-3, for example, when TRP beam correspondence may be indicated and DL resource and measurement may be more available and efficient than UL. A network may (e.g., also or alternatively) request P-1→P-2→P-3 to implement UL beam management, for example, when dual TRP/WTRU beam correspondence may be indicated.

A TRP may indicate to a WTRU which configuration to follow. In an example, one or more of the following UL beam management configurations may be provided: (i) Configuration 1 (00): U-1→U-2→U-3; (ii) Configuration 2 (01): U-1→U-2→P-3; (iii) Configuration 3 (10): U-1→P-2→U-3 and/or (iv) Configuration 4 (11): P-1→P-2→P-3.

A reference signal that enables U-1, U-2, and U-3 may be coupled with a timeslot format. One or more timeslots may be configured with a UL beam management RS. One or more timeslots may be configured with a DL beam management RS. A network may initiate UL beam management and may request a WTRU to perform an uplink implementation (e.g., U-1, U-2, or U-3). A WTRU may perform UL beam management based on one or more rules, such as one or more of the following rules.

In an example rule, U-1 may (e.g., is to) be performed and TRP/WTRU beam correspondence may be indicated. A WTRU may perform a U-1 implementation, for example, when a next opportunity may be a timeslot configured with a UL beam management RS. A WTRU may perform a P-1 implementation, for example, when a next opportunity may be a timeslot configured with a DL beam management RS. A WTRU may (e.g., otherwise) wait for a next opportunity (or timeslot) with a configured UL or DL beam management RS.

In an example rule, U-2 may (e.g., is to) be performed and TRP beam correspondence may be indicated. A WTRU may perform a U-2 implementation, for example, when a next opportunity may be a timeslot configured with a UL beam management RS. A WTRU may perform a P-2 implementation, for example, when a next opportunity may be a timeslot configured with a DL beam management RS. A WTRU may (e.g., otherwise) wait for a next opportunity (or timeslot) with a configured UL or DL beam management RS.

In an example rule, U-3 may (e.g., is to) be performed and WTRU beam correspondence may be indicated. A WTRU may perform a U-3 implementation, for example, when a next opportunity may be a timeslot configured with a UL beam management RS. A WTRU may perform a P-3 implementation, for example, when a next opportunity may be a timeslot configured with a DL beam management RS. A WTRU may (e.g., otherwise) wait for a next opportunity (or timeslot) with a configured UL or DL beam management RS.

Beam correspondence or reciprocity for a gNB or TRP may be determined and/or indicated, e.g., to assist and configure UL beam management. The results of beam correspondence or reciprocity may be signaled or indicated, e.g., to a WTRU. A gNB or TRP may signal or indicate the results of beam correspondence or reciprocity to a WTRU, for example, when a gNB or TRP determines beam correspondence or reciprocity. Signaling or indication may be, for example, semi-static or dynamic. In an example, the results of beam correspondence or reciprocity may be signaled or indicated via a DL response that may respond to, for example, an initial uplink transmission, random access response (RAR), NR-PRACH message 2, NR-PRACH message 4, NR-PDCCH, NR-ePDCCH, medium access control (MAC) or MAC control element (CE), radio resource control (RRC) signaling or the like.

Feedback may be periodic, aperiodic, per request, and/or based on demand. Feedback for results of gNB or TRP beam correspondence or reciprocity may be initiated by one or more of a WTRU, gNB, and/or TRP. Feedback for results of gNB or TRP beam correspondence or reciprocity may be triggered by an event. A gNB or TRP may (e.g., alternatively) signal or indicate the results of beam correspondence or reciprocity to a WTRU, e.g., as part of gNB or TRP capability, antenna or beam configuration.

In an example, results of beam correspondence or reciprocity or gNB or TRP capability, antenna or beam configuration that may include the results of beam correspondence or reciprocity may be signaled or indicated to a WTRU or other gNB or TRP, for example, via a DL response that responds to an initial uplink transmission, random access response (RAR), NR-PRACH message 2, NR-PRACH message 4, RRC signaling or the like.

In an (e.g., alternative) example, results of beam correspondence or reciprocity or gNB or TRP capability, antenna or beam configuration that may include the results of beam correspondence or reciprocity may be signaled or indicated to a WTRU or other gNB or TRP, for example, via NR-PBCH (e.g., using CRC masking or scrambling), or carried in NR-PBCH payload (e.g., directly) or a combination of CRC masking or scrambling and NR-PBCH payload.

In an example, a portion of gNB or TRP capability, antenna or beam configuration that may include the results of beam correspondence or reciprocity may be signaled or indicated to a WTRU or other gNB or TRP, for example, via NR-PBCH (e.g., using CRC masking or scrambling), and another part of gNB or TRP capability, antenna or beam configuration that may include results of beam correspondence or reciprocity may be carried (e.g., directly) in an NR-PBCH payload.

In an example, gNB or TRP capability, antenna or beam configuration that may include the results of beam correspondence or reciprocity may be signaled or indicated to a WTRU or other gNB or TRP in minimum system information or other system information that may be transmitted (e.g., periodically or based on demand).

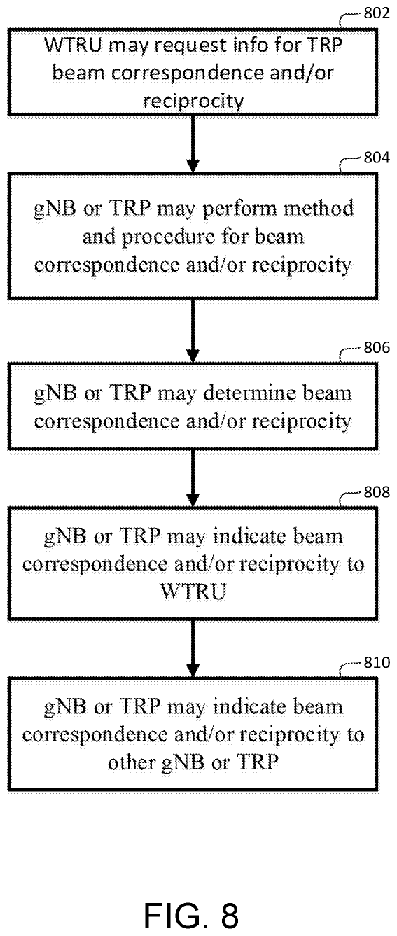

FIG. 8 is an example of a TRP beam correspondence determination and indication. At 802, a WTRU may request information for TRP beam correspondence and/or reciprocity. At 804, a gNB or TRP may perform an implementation for beam correspondence and/or reciprocity determination, e.g., based on a WTRU's request or without a WTRU's request. At 806, a gNB or TRP may determine beam correspondence/reciprocity, for example, according to the results of one or more implementations for beam correspondence and/or reciprocity determination. At 808, a gNB or TRP may indicate a beam correspondence and/or reciprocity to a WTRU. At 810, a gNB or TRP may indicate a beam correspondence and/or reciprocity to other gNB or TRP.

A beam correspondence determination may be made. Beam correspondence for TRP may be determined for UL beam management. One or more of the following may be performed.

A TRP may perform Tx beam sweeping.

A WTRU may determine one or more TRP Tx beams based on one or more measurements (e.g., beam reference signal (BRS)). One or more of the following may be performed.

A WTRU may provide information about selected TRP Tx beam information based on determined beams. A selected beam index or beam indices may be fed back to a TRP, for example, via one or more of an uplink control channel, WTRU feedback, CSI, NR-PRACH preamble(s), NR-PRACH resources, RACH Msg3, NR-PUCCH, NR-PUSCH, scheduling request (SR), or the like.

A TRP may perform TRP Rx beam sweeping.

A TRP may determine one or more TRP Rx beams based on measurement.

A TRP may derive one or more TRP Tx beams, for example, using the determined one or more TRP Rx beams, e.g., assuming beam correspondence at TRP.

Selected beams (e.g., a beam determined by a WTRU and a beam determined by the TRP) may be compared at a TRP. A TRP may determine final beam correspondence at the TRP based on a rule or a set of rules. In an example, beam correspondence at a TRP may be declared and determined, for example, when compared beams may be (e.g., are) the same. Beam correspondence at the TRP may not be declared and determined, for example, when the compared beams may not be the same. Measurement or metrics to determine beams or beam correspondence may be based on, for example, SNR, signal strength, power, beam-quality, CSI, or the like.

A WTRU may report its capability to a TRP, e.g., for UL beam management. A WTRU capability may include one or more (e.g., any combination) of the information related to UL beam management, such as one or more of the following: (i) WTRU beam correspondence and/or (ii) WTRU beam and antenna configuration.

A WTRU may or may not have beam correspondence capability may be based on a hardware limitation and/or Tx/Rx antenna configuration. A WTRU may not have beam correspondence capability. A WTRU may report beam correspondence (e.g., as part of WTRU capability) to a TRP. A TRP may assume a WTRU does not have beam correspondence, e.g., as default or baseline. A TRP may or may not assume a WTRU has beam correspondence during its connection life time. A WTRU may (e.g., temporarily) lose beam correspondence due to one or more reasons (e.g., asymmetric interference between uplink and downlink). A WTRU may report “loss of beam correspondence” or “beam correspondence confirmation,” for example, to indicate that during a connection the WTRU may lose or may not have beam correspondence. A “loss of beam correspondence” report and/or a “beam correspondence confirmation” report may be performed, for example, dynamically and/or semi-statically.

A WTRU may report “beam correspondence” (e.g., as part of WTRU capability) and “loss of beam correspondence” or “beam correspondence confirmation” (e.g., as part of RRC configuration signaling, MAC CE, or L1 control). For example, a WTRU status may include beam correspondence, loss of beam correspondence, and/or beam correspondence confirmation. A WTRU may report information to a network device, e.g., to enable more efficient UL beam management. In an example, a WTRU may report (e.g., statically or semi-statically), for example, one or more of the following: (i) WTRU beam correspondence (e.g., as part of WTRU capability) and/or (ii) WTRU beam and antenna configuration (e.g., as part of WTRU capability). In an example, a WTRU may report (e.g., semi-statically or dynamically), for example, one or more of the following: (i) a “Loss of beam correspondence” or “Beam correspondence hold/support: NO” and/or (ii) “Beam correspondence confirmation” or “Beam correspondence hold/support: YES”.

A static or semi-static report may be sent to a TRP, for example, during initial access, random access, or an RRC connection request stage. A static or semi-static report may be sent to a TRP, for example, after RRC connection establishment.

The WTRU beam correspondence capability may be (e.g., explicitly) provided in WTRU-capability information element (IE). For example, in the WTRU-NR-capability IE, an item (e.g., a syntax, or clause) may be added. The item may specify whether the WTRU supports beam correspondence. The item may specify what is the level that a WTRU supports beam correspondence. For example, the item may state WTRU-beamcorrespondence ENUMERATED {full, partial, no}, as shown in Table 2. The value of “full” may indicate that a WTRU supports the full beam correspondence, for example, beam sharing between a WTRU's Tx beams and the WTRU's Rx beams. The value of “no” may indicate that the WTRU does not support beam correspondence, for example, no beam sharing between a WTRU's Tx beams and the WTRU's Rx beams. The value of “partial” may indicate that the beam correspondence may not be perfect or full beam correspondence due to various reasons as discussed herein. For example, a WTRU's Tx beams may be some offset from the WTRU's Rx beams. The WTRU's beam correspondence may exist in certain frequency region(s) and may or may not exist in certain (e.g., other) frequency region(s). Partial beam correspondence may not be specified and/or signaled in WTRU-NR-capability IE. For example, partial beam correspondence may not be signaled in WTRU-NR-capability IE and dynamically indicated by L2 or L1 signaling such as MAC CE or DCI.

A WTRU capability of beam correspondence may include two-value states (e.g., either full beam correspondence or no beam correspondence). Partial beam correspondence may not be used as a value. Full beam correspondence or no beam correspondence may be selected and/or signaled in WTRU-NR-capability IE as (e.g., or defined as) WTRU-beamcorrespondence ENUMERATED {full, no} as shown in Table 3. Beam correspondence may not include (e.g., no beam correspondence) may include both partial beam correspondence and “no” beam correspondence as described herein.

TABLE 2

| | |
|---|---|
| WTRU-NR-Capability ::= | SEQUENCE { |
| ... | |
| wtru-beamcorrespondence | ENUMERATED {full,partial,no}, |
| ... | |
| } | |

TABLE 3

| | |
|---|---|
| WTRU-NR-Capability ::= | SEQUENCE { |
| ... | |
| wtru-beamcorrespondence | ENUMERATED {full,no}, |
| ... | |
| } | |

The WTRU beam correspondence capability may be reported (e.g., implicitly reported) during RACH procedure by Msg1. For example, some RACH resources or preambles may be reserved to indicate full beam correspondence. Some RACH resources or preambles (e.g., the RACH resources or preambles not reserved to indicate full beam correspondence) may be used to report that the WTRU does not have full beam correspondence.

A reference signal may be used for beam management. UL beam management may be initiated and controlled, for example, by a network or element thereof, such as a gNB or TRP. One or more reference signals may be used to facilitate UL beam management. One or more reference signals for UL beam management may be, for example, a sounding reference signal (SRS), UL DMRS, PRACH preambles, and/or other (e.g., new) UL RS.

In examples, a reference signal sequence r_{u,v}^{(α)}(n) may be a cyclic shift α of a base sequence r̅_{u,v}^{(α)}(n) according to r_{u,v}^{(α)}(n)=e^{jαn}r̅_{u,v}^{(α)}(n), 0≤n<M_{sc}^{RS}, where M_{sc}^{RS}=mN_{sc}^{RS} may be a length of the reference signal sequence and 1≤m≤N_{RB}^{max,UL}. Multiple reference signal sequences may be defined from a single base sequence through different values of α. Base sequences r̅_{u,v}^{(α)}(n) may be divided into groups, where u may be a group number and v may be a base sequence number within the group. A (e.g., each) group may contain a (e.g., one) base sequence of each length M_{sc}^{RS}=mN_{sc}^{RB}, 1≤m≤Thre and two or more base sequences of each length M_{sc}^{RB}=mN_{sc}^{RS}, (Thre+1)≤m≤N_{RB}^{max,UL}. The group hopping and sequence hopping within a group may be possible for SRS and UL DMRS.

A base sequence may be composed of ZC sequences. If the reference signal covers a few Resource Blocks (RBs) (e.g., only a few RB(s)), e.g., 1 or 2 RBs, then the base sequence may be directly defined. If the reference signal covers more RBs, then the base sequence could be the repeated version of a ZC sequence.

For NR-PUSCH, the DMRS could be defined as r_{NR-PUSCH}^{(λ)}(m·M_{sc}^{RS}+n)=w^{(λ)}(m)r_{u,v}^{(α}^{_{λ}}⁾(n), where m=0, 1, n=0, . . . , M_{SC}^{RS}−1. For NR-PUCCH, the DMRS could be defined as

$${r}_{NR \text{-} PUCCH}^{( \tilde{p} )} ( {m}^{′} {N}_{RS}^{NR \text{-} PUCCH} {M}_{sc}^{RS} + {mM}_{sc}^{RS} + n ) = \frac{1}{\sqrt{P}} {\overline{w}}^{( \tilde{p} )} ( m ) z ( m ) {r}_{u , v}^{( {α}_{\tilde{p}} )} ( n ) ,$$

where m=0, . . . , N_{RS}^{NR-PUCCH}−1, n=0, . . . , M_{SC}^{RS}−1, and m′=0,1.

For SRS, the reference signal sequence may be r_{SRS}^{(\tilde{p})} (n)=r_{u,v}^{(α}^{_{\tilde{p}}}⁾(n), where the cyclic shift may be configured by network. The SRS may be composed of ZC sequence. The length of ZC sequence may be of length of several RBs, e.g., depending on the network configurations.

The PRACH preambles may be composed of ZC sequences, where the base sequences in a group may be x_{u,v}(n)=xᵤ((n+Cᵥ)mod N_{ZC}), where N_{ZC} is the length of ZC sequence and the u^{th} root ZC sequence may be defined by

$${x}_{u} ( n ) = {e}^{- j \frac{π un ( n + 1 )}{{N}_{ZC}}} , 0 \leq n \leq {N}_{ZC} - 1$$

One or more alternatives to SRS, UL DMRS, and/or PRACH preambles may be used and may include m-sequence, Golay, unique word (UW) or UW-like, and so on. For example, multiple m-sequences with different lengths may be generated. A base sequence may be composed of m-sequence. If the reference signal covers a few RBs (e.g., only covers a few RBs), then the base sequence may be directly defined as m-sequence of certain lengths. If the reference signal covers more RBs, then the base sequence may be repeated m-sequences, or it may be the m-sequences repeated at symbol level. The base sequences may be divided into groups, and each group may contain one base sequence of length M_{sc}^{RS}=mN_{sc}^{RB}, for some m≤Thre, and two or more base sequences of each length M_{sc}^{RS}=mN_{sc}^{RB}, (Thre+1)≤m≤N_{RB}^{max,UL}. The group hopping or sequence hopping within a group may still be supported.

A TRP may decide which reference signals to use for UL beam management, for example, in an NW-controlled UL beam management environment. Details about reference signals for a (e.g., each) WTRU may be communicated to a (e.g., each) WTRU. A TRP's decision may depend on, for example, channel conditions, WTRU capability, and QoS requirements, etc. In an example, bandwidth allocated to a WTRU may be limited and a sequence length of a UL DMRS may be (e.g., subsequently) limited, for example, for a WTRU with low QoS requirements. A time interval between two SRS may (e.g., also) be larger. Less SRS or UL DMRS may be used, for example, when a channel between a WTRU and a TRP may experience flat fading. A (e.g., each) reference signal may be associated with one or more beam sweeping schemes for uplink beam management implementations (e.g., U1/U2/U3 implementations).

In an example (e.g., for U1 or U3 implementations), an SRS, UL DMRS or PRACH may be placed in different TX beam directions. In an example (e.g., for U2 implementations), an SRS, UL DMRS or PRACH may be placed in a (e.g., single) TX beam direction, e.g., for burst transmissions. Transmission on TX beams may enable necessary measurements (e.g., for U1 and U2 implementations) at different RX beam directions relative to a TRP.

A TRP may (e.g., first) determine which implementation to use for UL beam management. A TRP may decide for a given implementation whether SRS, UL DMRS or PRACH may be used for UL beam management. A TRP may determine a duration and time/frequency location of one or more reference signals. Association between an (e.g., each) implementation reference signal may be established. In an example, an implementation (e.g., U-1) may be associated with, for example, SRS, and implementations (e.g., U-2 and U-3) may be associated with, for example, UL DMRS. In an (e.g., another) example, an implementation (e.g., U-1) may be associated with, for example, a PRACH preamble, an implementation (e.g., U-2) may be associated with, for example, UL DMRS, and an implementation (e.g., U-3) may be associated with, for example, SRS. A reference signal type (e.g., SRS, UL DMRS, PRACH preamble) may be determined, e.g., based on an association, for example, when a beam management implementation (e.g., U-1, U-2, U-3) may be determined.

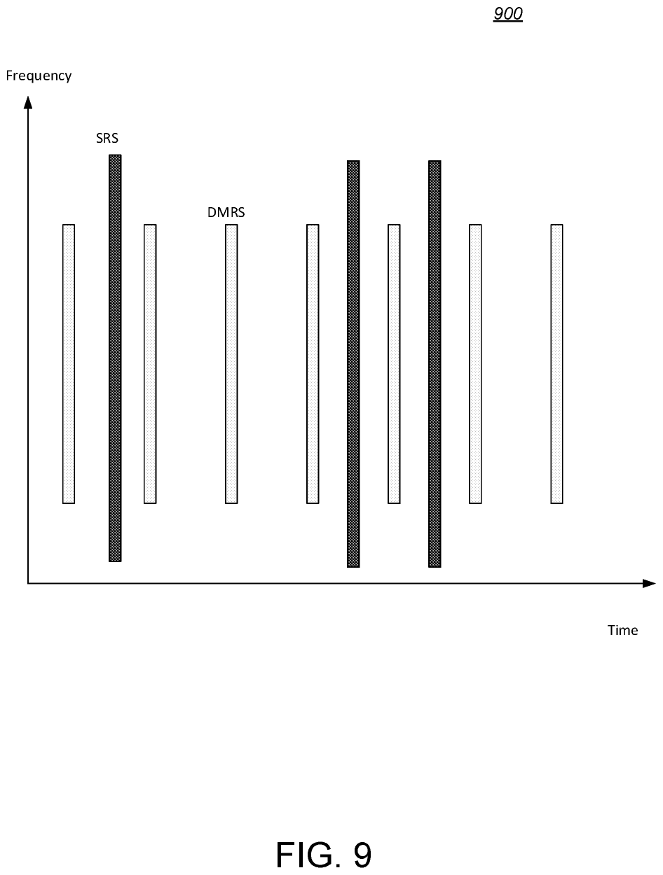

FIG. 9 is an example chart 900 depicting a distribution of DMRS and SRS over time and frequency domains.

UL beam management implementations may be provided for a single TRP and multi-TRP, for example, with or without multiple panels.

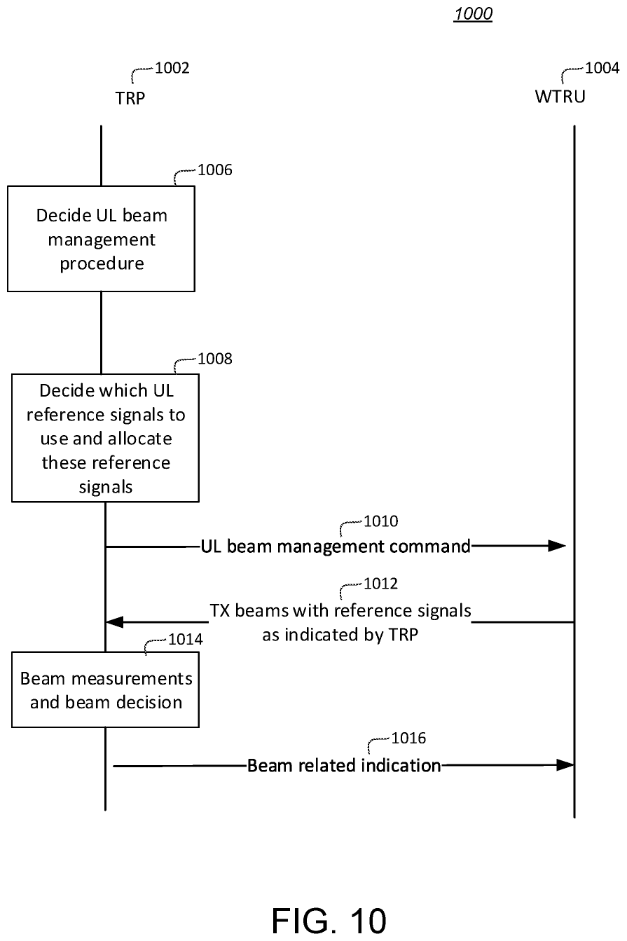

FIG. 10 is an example of a UL beam management implementation 1000 for a single TRP. UL beam management may be required, configured or activated. At 1006, a TRP 1002 may determine a UL beam management implementation (e.g., U1, U2, or U3). At 1008, the TRP 1002 may decide which UL reference signal (e.g., SRS, UL DMRS, PRACH) to use for a corresponding UL beam measurement implementation. The TRP 1002 may send an UL beam management command 1010 to a WTRU 1004. The UL beam management command 1010 may indicate a UL RS resource allocation to the WTRU 1004 for UL beam measurements. The WTRU 1004 may transmit a UL reference signal 1012 to the TRP 1002 for UL beam management. At 1014, the TRP 1002 may measure TRP Rx beams and/or WTRU Tx beams (e.g., according to U1, U2, and/or U3 implementations). For example, the TRP 1002 may (e.g., for U1 and/or U3) measure different WTRU Tx beams, e.g., to support selection of WTRU Tx beams. The TRP 1002 may (e.g., for U1 and/or U3) send a beam related indication 1016 to the WTRU 1004. The beam related indication 1016 may include beam related information. Beam related information may include one or more types of information, such as one or more of the following: (i) one or more selected WTRU Tx beam indexes; (ii) a corresponding RSRP for one or more selected WTRU Tx beams; (iii) one or more best UL beam pairs (e.g., WTRU's TX beam and/or TRP's RX beam); (iv) one or more backup UL beam pairs, etc.

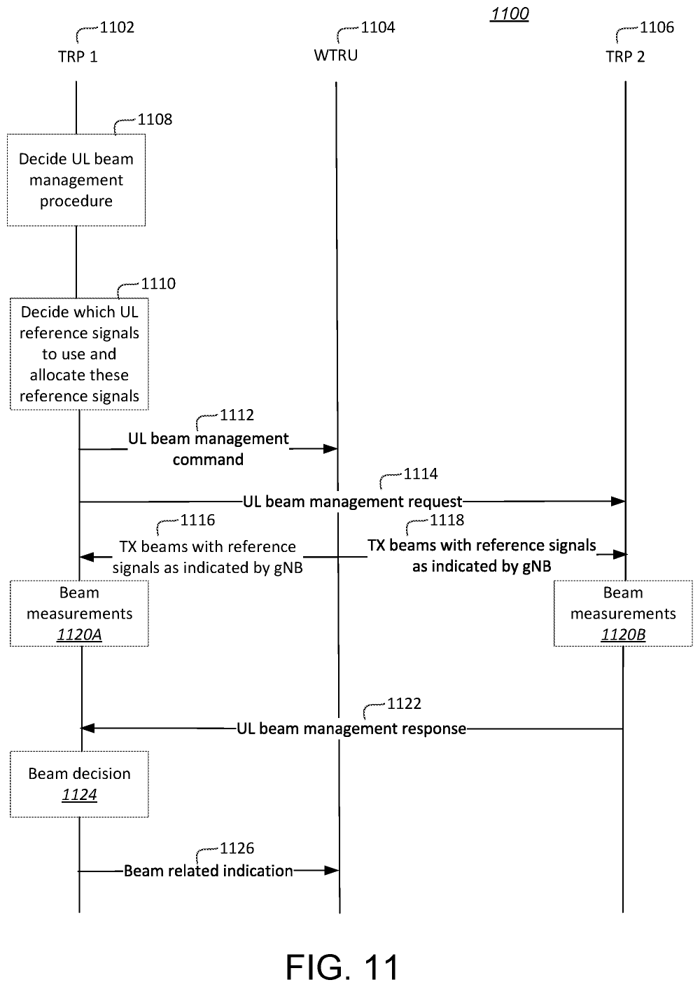

FIG. 11 is an example of UL beam management 1100 for multiple TRPs 1102, 1106. UL beam management may be between a WTRU 1104 and one or more TRPs, for example, such as TRPs 1102, 1106. UL beam management may be between a WTRU 1104 and different TRPs 1102, 1106, for example, in a multiple TRP scenario.

In an example, at 1108, a first TRP 1102 (e.g., TRP1) may (e.g., similar to a single TRP scenario) determine a UL beam management implementation (e.g., U1, U2, or U3) to follow. At 1110, the first TRP 1102 may (e.g., also) determine which reference signal types (e.g., SRS, UL DMRS, PRACH) and resources to use for a UL beam measurement. The first TRP 1102 may send (e.g., communicate) a resource allocation message 1112 to the WTRU 1104 and/or a second TRP (e.g., TRP2), which may help with UL beam measurements. The first TRP 1102 may send a message 1114 (e.g., an UL beam management request) to the second TRP 1106, for example, via an X2-like link between TRPs 1102, 1106. At 1116, 1118 the message 1114 may include information about which UL beam management implementation to follow and/or reference signal resources to use for one or more implementations. At 1120B the second TRP 1106 may, for example, start beam measurements upon receiving the message 1118 from the WTRU 1104. At 1120A, the first TRP 1102 may start beam measurements, for example, upon receiving a message 1116 from the WTRU 1104. The second TRP 1106 may (e.g., upon completion of measurement(s)) report measurement results to the first TRP 1102 using an UL beam management response 11221, e.g., via a direct link between TRPs. At 1124, the first TRP 1102 may make a decision, for example, based on beam measurement results from both TRPs. The first TRP 1104 may send a beam related indication 1126 to the WTRU 1104.

Features, elements and actions (e.g., processes and instrumentalities) are described by way of non-limiting examples. While examples may be directed to LTE, LTE-A, New Radio (NR), or 5G protocols, subject matter herein is applicable to other wireless communications, systems, services and protocols. Each feature, element, action, or other aspect of the described subject matter, whether presented in figures or description, may be implemented alone or in any combination, including with other subject matter, whether known or unknown, in any order, regardless of examples presented herein.

Systems, methods and instrumentalities have been disclosed for uplink beam management. Uplink (UL) Beam Management implementations may be provided for a single Transmission-Reception Point (TRP) and Multiple TRPs. A TRP may configure Uplink (UL) beam management. A TRP may configure a Wireless Transmit-Receive Unit (WTRU) beam sweep. A TRP may select and indicate a selected WTRU Tx beam. UL Beam Management may be based on, for example, beam correspondence and/or beam management RS timeslot availability. TRP correspondence and a reference signal (RS) used for beam management may be determined and indicated. WTRU Capability Reporting may be provided for UL Beam Management.

A WTRU may refer to an identity of the physical device, or to the user's identity such as subscription related identities, e.g., MSISDN, SIP URI, etc. WTRU may refer to application-based identities, e.g., user names that may be used per application.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as CD-ROM disks, and/or digital versatile disks (DVDs). A processor in association with software may be used to implement a radio frequency transceiver for use in a WTRU, terminal, base station, RNC, and/or any host computer.

1-15. (canceled)

16. A wireless transmit/receive unit (WTRU) comprising:
a memory; and
a processor configured to:
send, to a network device, a first beam correspondence indication that indicates a beam correspondence associated with one or more receive beams and one or more transmit beams of the WTRU;
determine an uplink time synchronization status associated with the WTRU;
send, to the network device, the determined uplink time synchronization status;
receive, from the network device, a reference signal type in accordance with the determined uplink time synchronization status;
receive, from the network device, a first beam management indication in response to the first beam correspondence indication;
perform an uplink beam management based on the received first beam management indication, wherein the uplink beam management comprises being configured to send reference signals having the reference signal type from a subset of WTRU transmit beams based on the beam correspondence;
determine a loss of the beam correspondence;
send, to the network device, a second beam correspondence indication that indicates the loss of the beam correspondence; and
adjust the uplink beam management based on the determined loss of the beam correspondence.

17. The WTRU of claim 16, wherein the uplink beam management comprises a reduced set of beam measurements when compared to an uplink beam management with no beam correspondence.

18. The WTRU of claim 16, wherein the uplink beam management comprises the processor being configured to:
skip one or more beam measurements based on the beam correspondence; and
use one or more downlink measurements for the one or more skipped beam measurements.

19. The WTRU of claim 16, wherein the beam correspondence indicates that the processor is configured to one or more of:
determine a transmit beam based on a downlink measurement on one or more receive beams of the WTRU; or
determine a receive beam based on an uplink measurement on one or more transmit beams.

20. The WTRU of claim 16, wherein the uplink time synchronization status indicates whether the WTRU is uplink time synchronized.

21. The WTRU of claim 20, wherein the received reference signal type is a new radio (NR) sounding reference signal (SRS) when the WTRU is uplink time synchronized, and wherein the received reference signal type is a NR physical random access channel (PRACH) preamble when the WTRU is not uplink time synchronized.

22. The WTRU of claim 16, wherein the network device is a transmission/reception point (TRP).

23. The WTRU of claim 16, wherein the processor is further configured to receive, from the network device, a second beam management indication, and wherein the beam management is adjusted based on the second beam management indication.

24. A method comprising:
sending, from a wireless transmit/receive unit (WTRU) to a network device, a first beam correspondence indication that indicates a beam correspondence associated with one or more receive beams and one or more transmit beams of the WTRU;
determining an uplink time synchronization status associated with the WTRU;
sending, to the network device, the determined uplink time synchronization status;
receiving, from the network device, a reference signal type in accordance with the determined uplink time synchronization status;
receiving, from the network device, a first beam management indication in response to the first beam correspondence indication;
performing an uplink beam management based on the received first beam management indication, wherein the uplink beam management comprises sending reference signals having the reference signal type from a subset of WTRU transmit beams based on the beam correspondence;
determining a loss of the beam correspondence;
sending, to the network device, a second beam correspondence indication that indicates the loss of the beam correspondence; and
adjusting the uplink beam management based on the determined loss of the beam correspondence.

25. The method of claim 24, wherein the uplink beam management comprises a reduced set of measurements when compared to an uplink beam management with no beam correspondence.

26. The method of claim 24, wherein the uplink beam management comprises:
skipping one or more beam measurements based on the beam correspondence; and
using one or more downlink measurements for the one or more skipped beam measurements.

27. The method of claim 24, wherein the beam correspondence indicates one or more of:
determining a transmit beam based on a downlink measurement on one or more receive beams of the WTRU; or
determining a receive beam based on an uplink measurement on one or more transmit beams.

28. The method of claim 24, wherein the uplink time synchronizations status indicates whether the WTRU is uplink time synchronized.

29. The method of claim 28, wherein the received reference signal type is a new radio (NR) sounding reference signal (SRS) when the WTRU is uplink time synchronized, and wherein the received reference signal type is a NR physical random access channel (PRACH) preamble when the WTRU is not uplink time synchronized.

30. The method of claim 24, further comprising receiving, from the network device, a second beam management indication, and wherein the beam management is adjusted based on the second beam management indication.
